(19) United States
(12) Patent Application Publication
(10) Pub. No.: US 2016/0327483 A1
(43) Pub. Date: Nov. 10, 2016

(54) LIQUID MIXTURE SENSORS AND SYSTEMS AND METHODS UTILIZING THE SAME

(71) Applicant: Bucknell University, Lewisburg, PA (US)

(72) Inventors: Keith Mattern, Lake Ariel, PA (US); Daniel Willard, Cranberry Twp., PA (US); Joel Wood, Leesport, PA (US); James Maneval, Lewisburg, PA (US)

(73) Assignee: Bucknell University, Lewisburg, PA (US)

(21) Appl. No.: 15/146,011

(22) Filed: May 4, 2016

Related U.S. Application Data
(60) Provisional application No. 62/156,629, filed on May 4, 2015.

(51) Int. Cl. G01N 21/59

(52) U.S. Cl. CPC G01N 21/59; G01N 2201/0833; G01N 2201/062

(57) ABSTRACT

One aspect of the invention provides a sensor including: one or more fiber optic emitters and one or more fiber optic receivers lying in the same plane and spaced from, but proximate to the one or more fiber optic emitters. Another aspect of the invention provides a sensor including: one or more fiber optic emitters and one or more fiber optic receivers spaced from, but proximate to the one or more fiber optic emitters. Each of the one or more fiber optic receivers have an end that lies outside of a light beam emitted by the one or more fiber optic emitters.

### CROSS-REFERENCE TO RELATED APPLICATION

This application claims priority under 35 U.S.0 § 119(e) to U.S. Provisional Patent Application Ser. No. 62/156,629, filed May 4, 2015. The entire content of this application is hereby incorporated by reference herein.

### BACKGROUND OF THE INVENTION

Characterizing the quality of two-phase systems is important in many fields including manufacturing. For example, measurement of the solid content in a suspension is an important parameter that characterizes liquid-solid suspensions and the time-to-dissolution of a solid phase in a liquid mixture is important for preparation of pharmaceutical products.

### SUMMARY OF THE INVENTION

One aspect of the invention provides a sensor including: one or more fiber optic emitters and one or more fiber optic receivers lying in the same plane and spaced from, but proximate to the one or more fiber optic emitters.

This aspect of the invention can have a variety of embodiments. The one or more fiber optic receivers can be spaced from the one or more fiber optic emitters by between about 1 cm and about 5 cm.

Another aspect of the invention provides a sensor including: one or more fiber optic emitters and one or more fiber optic receivers spaced from, but proximate to the one or more fiber optic emitters. Each of the one or more fiber optic receivers have an end that lies outside of a light beam emitted by the one or more fiber optic emitters.

This aspect of the invention can have a variety of embodiments. The one or more fiber optic receivers can be spaced from the one or more fiber optic emitters by between about 1 cm and about 5 cm.

Another aspect of the invention provides a sensor including: one or more fiber optic emitters and one or more fiber optic receivers spaced from, but substantially parallel to the one or more fiber optic emitters. The one or more and the one or more fiber optic emitters and the one or more fiber optic receivers can each include an unclad end.

This aspect of the invention can have a variety of embodiments. The unclad end can have a length of at least about 1 cm. The fiber optic emitter and the one or more fiber optic receivers can be substantially identical.

The sensor can include one fiber optic emitter and three fiber optic receivers. The three fiber optic receivers can be equidistantly spaced from the fiber optic emitter. The three fiber optic receivers can be spaced at equal angles relative to the fiber optic emitter.

Another aspect of the invention provides a mixing sensing system including: the sensor as described herein and an analyzer. The analyzer includes: a light source adapted and configured for optical coupling with the one or more fiber optic emitters of the sensor and one or more photodiodes adapted and configured for optical coupling with the one or more fiber optic receivers of the sensor.

This aspect of the invention can have a variety of embodiments. The analyzer can further include an amplifier in communication with the one or more photodiodes. The amplifier can be an operational amplifier. The operational amplifier can be coupled to a feedback loop to set a gain for the operational amplifier. The feedback loop can include a first resistor and a second resistor.

The light source can be an LED. The light source can be a high luminous flux LED. The high luminous flux LED can have a flux value greater than about 100 lumens. The light source can produce light in at least the ultraviolet, visible, or infrared range. The analyzer can further include a controller at least communicatively coupled with the one or more photodiodes and programmed to detect deviations in light received by the photodiode.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a sensor according to an embodiment of the invention.

FIG. 2 depicts a system according to an embodiment of the invention.

FIG. 3 depicts an amplifying circuit according to an embodiment of the invention.

FIG. 4 depicts a system according to an embodiment of the invention.

FIG. 5 a method of monitoring the state of a liquid mixture according to an embodiment of the invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Embodiments of the invention provide sensors and systems and methods utilizing the same. Embodiments of the invention can provide more accurate measurements of liquid content that can be used, for example, to determine the mixing end point of a solution of dissolving particles.

### Sensors

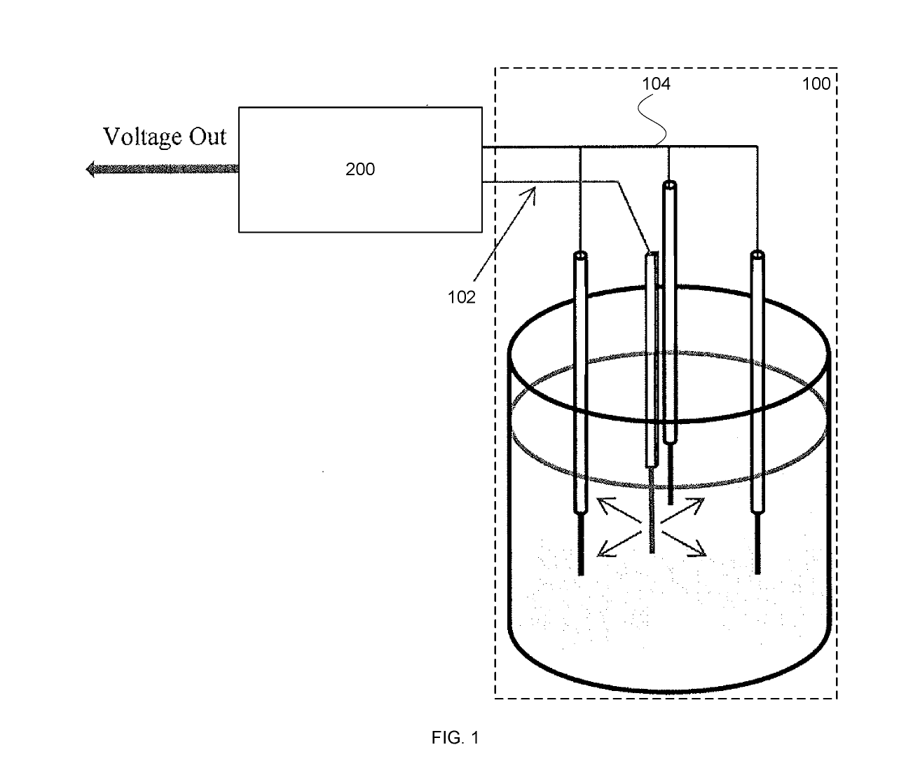

Referring now to FIG. 1, one embodiment of the invention provides a sensor 100 including one or more fiber optic emitters 102 and one or more fiber optic receivers 104. Both fiber optic emitter(s) 102 and fiber optic receiver(s) 104 can be adapted and configured for whole or partial immersion in a liquid. For example, fiber optic emitter(s) 102 and fiber optic receiver(s) 104 can be fabricated from materials that are compatible with a target liquid. For example, fiber optic emitter(s) 102 and fiber optic receiver(s) 104 can be fabricated from materials that capable of withstanding immersion in polar and/or non-polar liquids depending of the target liquid. For example, the cladding of fiber optic emitter(s) 102 and fiber optic receiver(s) 104 can be functionalized to withstand a target liquid environment.

Without being bound by theory, Applicant believes that variations in the content and/or characteristics of a liquid mixture can be detected based on the optical transmissivity of the liquid mixture. Accordingly, a variety of structures can be utilized to introduce light into the liquid and collect light from the liquid. For example, the fiber optic emitter(s) 102 and fiber optic receiver(s) 104 can have blunt ends in which both the optical fiber and surrounding cladding are cut flush with each other (e.g., perpendicular) to a central axis of the optical fiber. In other embodiments, a diffuser, a prism, a lens, and/or other optical element can be coupled to ends of the fiber optic emitter(s) 102 and fiber optic receiver(s) 104. In still another embodiment, a length of cladding (e.g., between about 0 cm and about 1 cm, between about 1 cm and about 2 cm, between about 2 cm and about 3 cm, and the like) is removed, which can allow light to be emitted and received through sidewalls of the fiber core.

Likewise, and again without being bound by theory, the one or more fiber optic emitters 102 and one or more fiber optic receivers 104 can be arranged in a variety of positions. In one embodiment, a plurality of fiber optic receivers 104 are arranged around one or more fiber optic emitters 102. For example, a single fiber optic emitter 102 can be surrounded by a plurality of equally spaced (e.g., with regard to distance and/or angle with respect to the single fiber optic emitter 102) from fiber optic receivers 104. For example, fiber optic receiver(s) 104 can be spaced by between about 1 cm and about 5 cm from fiber optic emitter 102.

In some embodiments, the ends and/or the unclad regions of the one or more fiber optic emitters 102 and one or more fiber optic receivers 104 lie in the same plane. In some embodiments, the one or more fiber optic emitters 102 and one or more fiber optic receivers 104 are not arranged linearly or coaxially in which light emerging axially from a fiber optic emitter 102 would have a direct, axial path to a fiber optic receiver 104.

Without being bound by theory, light can travel through a variety of paths between the one or more fiber optic emitters 102 and one or more fiber optic receivers 104. For example, all or portions of the light can travel directly between the one or more fiber optic emitters 102 and one or more fiber optic receivers 104, scatter and/or reflect off of components of the liquid mixture, reflect off a surface and/or boundary of the liquid mixture, and/or reflect off a vessel containing the liquid mixture. The various proportions of light that travels between the one or more fiber optic emitters 102 and one or more fiber optic receivers 104 and/or the total amount of light received at the one or more fiber optic receivers 104 can vary between sensors 100 and/or liquids. However, changes in the liquid mixture will be reflected in changes in the quantity of light received at the one or more fiber optic receivers 104 for a substantially constant light input via the one or more fiber optic emitters 102.

Fiber optic emitter(s) 102 and fiber optic receiver(s) 104 can be fabricated from a variety of fiber optics such as single mode fiber (e.g., fiber having a core diameter of less than about 10 μm) or multimode fiber (e.g., fiber having a core diameter greater than about 10 μm).

### Systems

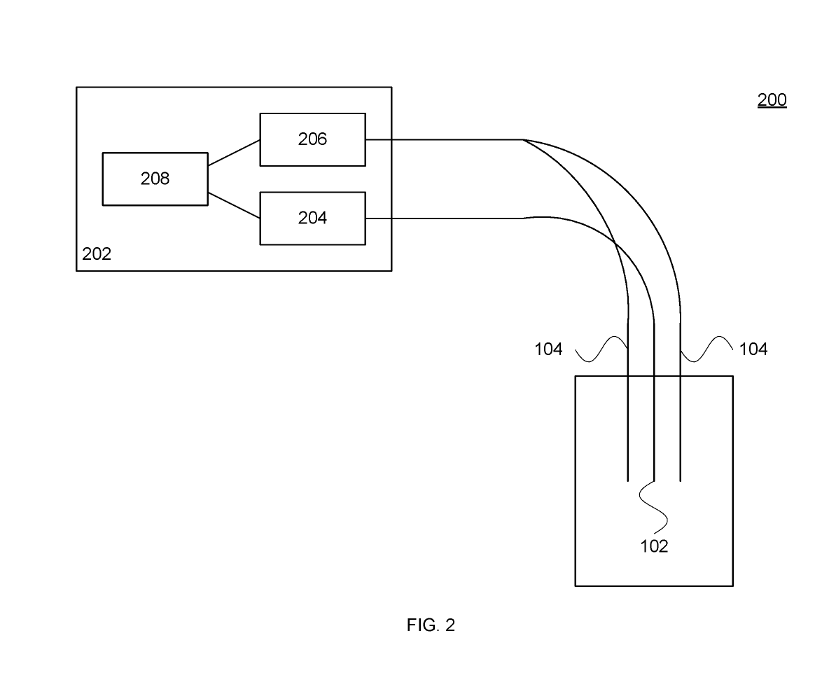

Referring now to FIG. 2, another aspect of the invention provides a system 200 including a sensor 100 and an analyzer 202. Analyzer can include a light source 204 and one or more photodiodes 206. Light source 204 and photodiodes 206 can be adapted and configured for optical coupling (e.g., with one or more fittings, plugs, adapters, and the like) with the one or more fiber optic emitters 102 and the one or more fiber optic receivers 104, respectively, of the sensor 100. Sensor 100 can advantageously be separate from analyzer 202 in order to isolate light source 204 and photodiodes 206 from the liquid and allow sensor 100 to be disposable. A variety of light source(s) 204 can be utilized. In one embodiment, the light source 204 includes a high luminous flux light-emitting diode (LED). Light source 204 can be designed and/or tunable to produce a given amount of light (e.g., measured in lumens, watts, and the like) at one or more defined wavelengths or ranges of wavelengths or frequencies. For example, light sources can produce over 100 lumens of light in one or more of the ultraviolet (10 nm to 380 nm), visible (400 nm to 700 nm), and/or infrared (700 nm to 1 mm) ranges. In one embodiment, the LED operates in the visible spectrum with a luminous flux of 440 lumens, 6.3 Watts, and a dominant wavelength of 623 nm.

Analyzer 202 can further include one or more controller 208 adapted, configured, and/or programmed to produce one or more outputs reflecting changes in the amount of light received by the one or more photodiodes. In one embodiment, the computing device provides a continuous or periodic reading of values (e.g., individual, summed, average, or the like) generated by photodiodes 204. In other embodiments, various techniques are applied to compensate for noise.

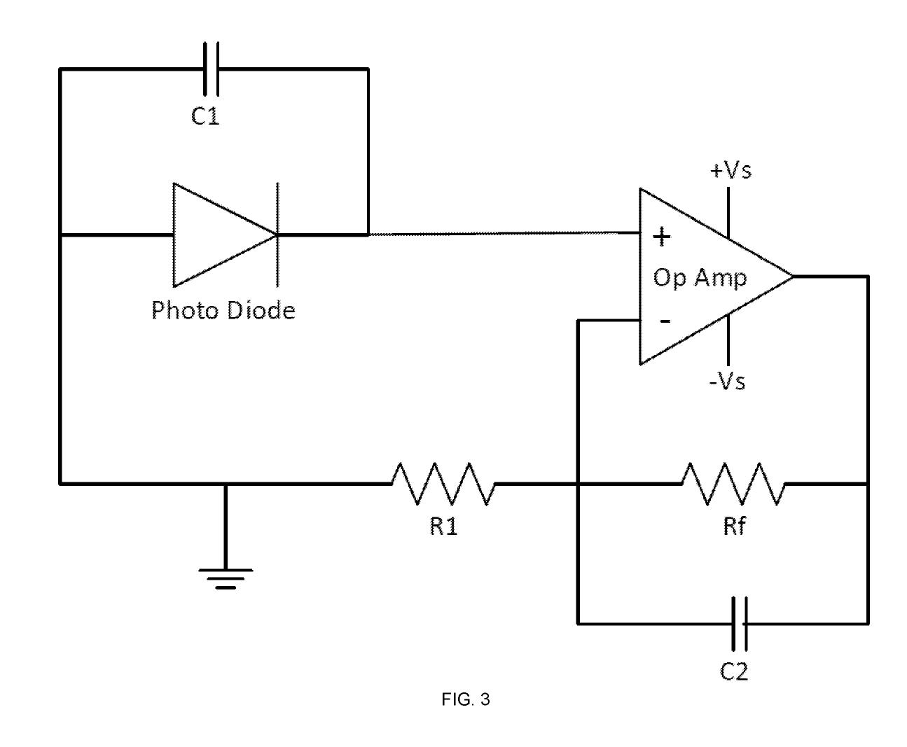

One exemplary approach to address noise is depicted in FIG. 3. The input to the circuit is a photodiode 204 that converts photons of light into an electrical signal. This signal can then be input into an operational amplifier, or “op amp”. An op amp functions by changing its output to reflect changes in the input as well as to convert an input current to an output value. A feedback loop can be used to allow for continuous adjustment of the input and to set a gain on the amplifier. The gain can be determined by the ratio of the two resistors and can act as a multiplier on the input voltage. Equation (1) can be used to calculate output voltage.

$${V}_{OUT} = ( 1 + \frac{{R}_{F}}{{R}_{1}} ) {V}_{IN} \qquad ( 1 )$$

Equation 1 shows that a change in resistance for either resistor will lead to an increase or decrease in gain. This allows for adjustment of the circuit. If the photodiode is outputting very small voltages, a high gain can be used to amplify this signal to a level that is easily interpreted and better displays small changes in the system. However, large gains also cause an increase in noise in the data, so a balance can be found between the necessary gain and the noise introduced to the system.

Controller or control unit 208 can be adapted, configured, and/or programmed to control operation of the one or more light source(s) 204 and/or photodiode(s) 206.

In one embodiment, light source(s) 204 and/or photodiode(s) 206 are communicatively coupled (e.g., through wired or wireless communication equipment and/or protocols) with the control unit 208. The control unit 208 can be an electronic device programmed to control the output of the one or more light sources 204. The control unit 208 can be programmed to autonomously control light sources 204 without the need for input from a user or can incorporate such inputs.

Control unit 208 can be a computing device such as a microcontroller (e.g., available under the ARDUINO® OR IOIO™ trademarks), general purpose computer (e.g., a personal computer or PC), workstation, mainframe computer system, and so forth. Control unit 208 can include a processor device (e.g., a central processing unit or “CPU”), a memory device, a storage device, a user interface, a system bus, and a communication interface.

Processor can be any type of processing device for carrying out instructions, processing data, and so forth.

Memory device can be any type of memory device including any one or more of random access memory (“RAM”), read-only memory (“ROM”), Flash memory, Electrically Erasable Programmable Read Only Memory (“EEPROM”), and so forth.

Storage device can be any data storage device for reading/writing from/to any removable and/or integrated optical, magnetic, and/or optical-magneto storage medium, and the like (e.g., a hard disk, a compact disc-read-only memory “CD-ROM”, CD-Re Writable “CDRW”, Digital Versatile Disc-ROM “DVD-ROM”, DVD-RW, and so forth). Storage device can also include a controller/interface for connecting to system bus. Thus, memory device and storage device are suitable for storing data as well as instructions for programmed processes for execution on processor.

User interface can include a touch screen, control panel, keyboard, keypad, display, or any other type of interface, which can be connected to system bus through a corresponding input/output device interface/adapter.

Communication interface can be adapted and configured to communicate with any type of external device, including sensors. Communication interface can further be adapted and configured to communicate with any system or network, such as one or more computing devices on a local area network (“LAN”), wide area network (“WAN”), the Internet, and so forth. Communication interface can be connected directly to system bus or can be connected through a suitable interface.

Control unit 208 can, thus, provide for executing processes, by itself and/or in cooperation with one or more additional devices, that can include algorithms for controlling light source(s) 204 and/or processing signals produced by photodiodes 206 in accordance with the present invention. Control unit 208 can be programmed or instructed to perform these processes according to any communication protocol and/or programming language on any platform. Thus, the processes can be embodied in data as well as instructions stored in memory device and/or storage device or received at user interface and/or communication interface for execution on processor.

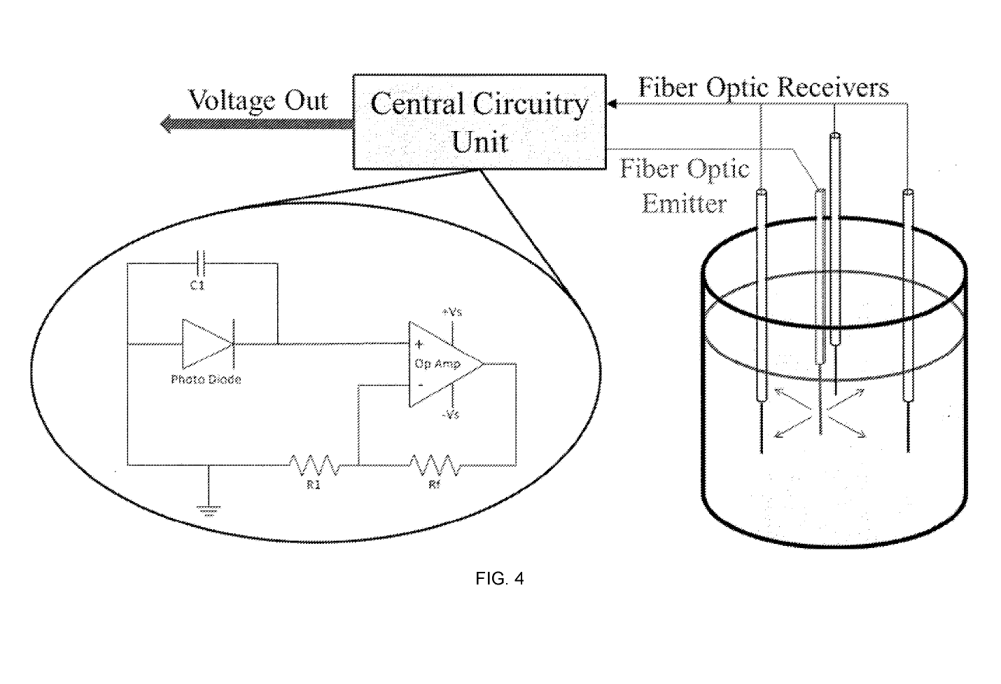

FIG. 4 depict an integration of the circuit 300 within a system 200 including sensor 100.

### Methods of Use

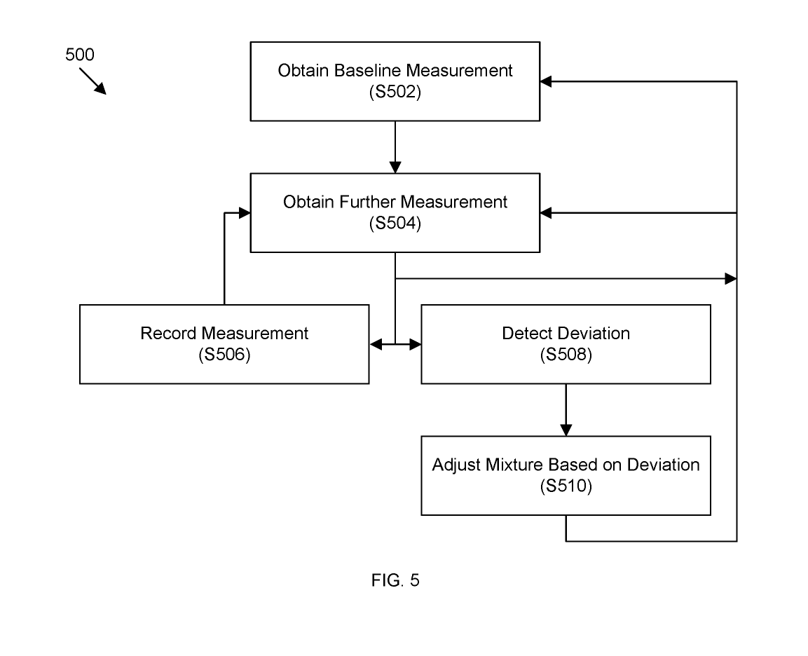

Referring now to FIG. 5, another embodiment of the invention provides a method 500 of monitoring the state of a liquid mixture.

In step S502, a baseline measurement is obtained (e.g., using the sensors 100 and/or systems 200 described herein). The baseline measurement can be verified or correlated with a desired mixture state for a particular application.

In step S504, a further measurement is obtained (e.g., using the sensors 100 and/or systems 200 described herein).

In step S506, one or more measurements are recorded and/or displayed (e.g., in electronic form). In step S506, a deviation is detected.

In step S508, the mixture can be adjusted, e.g., to restore the desired baseline measurement by action based on the deviation that was detected.

The method 500 can then be repeated (e.g., at defined intervals).

### Exemplary Applications

Embodiments of the invention can be applied to detect changes in state of a variety of liquid mixtures such as liquid-gas mixtures (e.g., solutions, colloids, suspensions, foams, and the like), liquid-liquid mixtures (e.g., solutions, colloids, suspensions, emulsions, and the like), and liquid-solid mixtures (e.g., solutions, colloids, suspensions, sols, and the like). Exemplary applications include measuring: dissolution endpoints for dissolving solids, emulsion quality, or degree of mixing of a solution. Other exemplary applications include determining a uniform suspension state and solubility limits. Still another exemplary application is monitoring waste water streams for suspended solids content.

### Equivalents

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A sensor comprising:
one or more fiber optic emitters; and
one or more fiber optic receivers lying in the same plane and spaced from, but proximate to the one or more fiber optic emitters.

2. The sensor of claim 1, wherein the one or more fiber optic receivers are spaced from the one or more fiber optic emitters by between about 1 cm and about 5 cm.

3. A sensor comprising:
one or more fiber optic emitters; and
one or more fiber optic receivers spaced from, but proximate to the one or more fiber optic emitters, each of the one or more fiber optic receivers having an end that lies outside of a light beam emitted by the one or more fiber optic emitters.

4. The sensor of claim 3, wherein the one or more fiber optic receivers are spaced from the one or more fiber optic emitters by between about 1 cm and about 5 cm.

5. A sensor comprising:
one or more fiber optic emitters, the one or more fiber optic emitters each including an unclad end; and
one or more fiber optic receivers spaced from, but substantially parallel to the one or more fiber optic emitters, the one or more fiber optic receivers each including an unclad end.

6. The sensor of claim 5, wherein the unclad end has a length of at least about 1 cm.

7. The sensor of claim 5, wherein the fiber optic emitter and the one or more fiber optic receivers are substantially identical.

8. The sensor of claim 5, wherein the sensor includes one fiber optic emitter and three fiber optic receivers.

9. The sensor of claim 8, wherein the three fiber optic receivers are equidistantly spaced from the fiber optic emitter.

10. The sensor of claim 8, wherein the three fiber optic receivers are spaced at equal angles relative to the fiber optic emitter.

11. A mixing sensing system comprising:
the sensor of claim 5; and
an analyzer comprising:
a light source adapted and configured for optical coupling with the one or more fiber optic emitters of the sensor; and
one or more photodiodes adapted and configured for optical coupling with the one or more fiber optic receivers of the sensor.

12. The mixing sensing system of claim 11, wherein the analyzer further comprises:
an amplifier in communication with the one or more photodiodes.

13. The mixing sensing system of claim 12, wherein the amplifier is an operational amplifier.

14. The mixing sensing system of claim 13, wherein the operational amplifier is coupled to a feedback loop to set a gain for the operational amplifier.

15. The mixing sensing system of claim 14, wherein the feedback loop includes a first resistor and a second resistor.

16. The mixing sensing system of claim 11, wherein the light source is an LED.

17. The mixing sensing system of claim 11, wherein the light source is a high luminous flux LED.

18. The mixing sensing system of claim 17, wherein the high luminous flux LED has a flux value greater than about 100 lumens.

19. The mixing sensing system of claim 11, wherein the light source produces light in at least the ultraviolet, visible, or infrared range.

20. The mixing sensing system of claim 11, wherein the analyzer further comprises:
a controller at least communicatively coupled with the one or more photodiodes and programmed to detect deviations in light received by the photodiode.
